(19) United States
(12) Patent Application Publication
(10) Pub. No.: US 2012/0085594 A1
(43) Pub. Date: Apr. 12, 2012

(54) Drive Arrangement for Machine Roomless Elevator

(76) Inventor: Tim Wright, Louisville, KY (US)

(21) Appl. No.: 13/252,582

(22) Filed: Oct. 4, 2011

Related U.S. Application Data
(60) Provisional application No. 61/391,841, filed on Oct. 11, 2010.

(51) Int. Cl. B66B 11/08

(52) U.S. Cl. 187/266

(57) ABSTRACT

A drive arrangement for an elevator car and a machine roomless elevator incorporates a machine having a drive sheave, a pair of right and left car side sheaves disposed beneath the car, a counterweight with a pair of top mounted sheaves, and a hoist cable including a plurality of ropes. The car is shifted to one side of the hoistway and the car guide rails are shifted forward in the hoistway in order to create a large pocket in a rear corner of the hoistway for the counterweight. In this manner, the elevator car can nest beside the machine in the top of the hoistway limiting the required top hoistway space and creating a minimal hoistway footprint.

### RELATED APPLICATION

This Application claims priority from provisional application Ser. No. 61,391,841, filed Oct. 11, 2010.

### BACKGROUND OF THE INVENTION

Elevators typically include a car guided for vertical movement within an elevator hoistway. Typically, a machine drives a rope around a series of sheaves driving the elevator car and a connected counterweight. Historically, the machine was mounted in a room above or beside the elevator hoistway. Thus, a good deal of additional space was required above or beside the hoistway, which is undesirable.

More recently, so-called “machine roomless” (MRL) elevators have been designed. In such constructions, the machine is incorporated in a small space within the elevator hoistway. A separate room is not then required.

Traditional MRL elevators, as shown in FIG. 5 and FIG. 6, necessarily require the hoistway 10 to have an enlarged width of the hoistway for at least two reasons:
1. With the machine 12 and the drive sheave 14 located between the car guide rail 16L and the hoistway wall 10L, extra space is required increasing the necessary width of the hoistway 10.
2. With the car guide rails 16R and 16L and the car frame 28R and 28L approximately located at the front to back center of gravity of the car 22, the counterweight 20 is confined to a limited space between the counterweight guide rails 18F and 18R. Since the counterweight 20 is confined in this manner between the counterweight guide rails 18F and 18R, the width of the hoistway 10 must necessarily increase in order to garner enough space for the counterweight 20.

Additionally, traditional MRL elevators exert extra pressure on the sides of the car guide rails 16R and 16L due to the car ropes 26 and car sheaves 24R and 24L being forward of the center of gravity of the car 22.

Additionally, traditional MRL elevators can penetrate the hoistway wall 10L, as shown in FIG. 5, requiring special provisions outside the hoistway 10 for required fire isolation.

Additionally, traditional MRL elevators can require structural reinforcement integrally in the building structure for handling the concentrated loading of the machine 12.

As an alternative, traditional MRL elevators may need extra space at the top of the hoistway, if the machine 12 is rotated 180 degrees, as illustrated in FIG. 6, to prevent penetration of the hoistway 10. In this configuration, the machine resides over the car frame 28L increasing the required space at the top of the hoistway 10 in order to maintain the proper clearance requirements.

It is one object of the present invention to provide an improved machine roomless elevator capable of solving the above-mentioned problems in the prior art resulting in reduction of the pressure on the sides of the car guide rails, reduction of the need for additional hoistway width, support for the driving unit inside the hoistway, and reduction of the space necessary in the top of the elevator hoistway that is conventionally required for maintaining a top clearance between the ceiling of the elevator hoistway and the car, if stopped in its highest position in the elevator hoistway.

### SUMMARY OF THE INVENTION

In one disclosed embodiment of this invention, the car is shifted to one side within the hoistway, and the car guide rails are shifted forward in order to create a large pocket in a rear corner of the elevator hoistway for the counterweight. This component arrangement utilizes a roping design that uniquely allows the hoistway footprint to remain minimal. The machine is affixed atop the counterweight guide rails via a bedplate in a position so that the drive sheave connects the nearest car side sheave and the center line of the counterweight. On one end the hoist ropes are divided around a pair of counterweight sheaves mounted to a top of the counterweight and secured to the bedplate connecting the machine to the top of the counterweight guide rails, and on the other end, the hoist ropes are secured to a hitching device in the top of the hoistway on the far side of the car away from the counterweight. In this manner, the elevator car can nest beside the machine in the top of the hoistway limiting the required space at the top of the hoistway. In addition, this arrangement does not necessitate penetration of the hoistway wall.

### BRIEF DESCRIPTION OF THE DRAWINGS

FIG. 1 is a top view of an embodiment of an improved machine roomless elevator system.

FIG. 2 is a side view of the counterweight and the counterweight roping detail of the embodiment of the elevator system of FIG. 1.

FIG. 3 is a front view of the relationship of the elevator car and the counterweight and the car roping detail of the embodiment of the elevator system of FIG. 1.

FIG. 4 is a side view of the elevator car at its vertically uppermost position of the embodiment of the elevator system of FIG. 1.

FIG. 5 is a top view of a MRL of the prior art.

FIG. 6 is a top view of an alternative MRL of the prior art.

### DETAILED DESCRIPTION OF THE PREFERRED EMBODIMENTS

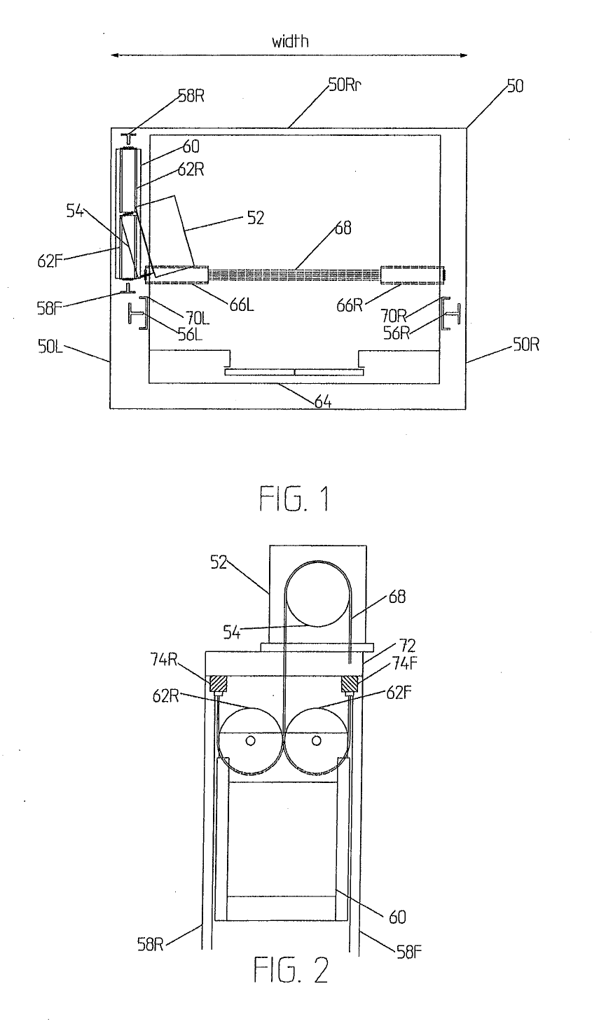

One embodiment of the current invention is illustrated in FIG. 1 through FIG. 4. However, the specific location of the car within the hoistway is not limited by the designs shown in these Figures. The side of the hoistway where the equipment is located is determined based on placement of the door opening therein.

One embodiment of the current invention, as illustrated in FIG. 1, is an elevator without a machine room having a car 64 within a hoistway 50 movable upwardly and downwardly, a drive machine 52 with an associated drive sheave 54, a counterweight 60, a hoist cable 68 including a plurality of ropes, and associated sheaves 62F, 62R, 66R, and 66L which is described in greater detail below.
The car 64, the car frame 70R and 70L, and opposing car guide rails 56R and 56L are positioned proximate to the hoistway wall 50R creating space for the counterweight 60 in the opposite rear corner.
The car frame 70R and 70L and opposing car guide rails 56R and 56L are positioned forward of the car sheaves 66R and 66L which are disposed under the car 64.
A pocket is thus created in the space between the car 64 and the hoistway wall 50L and between the car guide rail 56L and the rear wall of the hoistway 50Rr wherein the counterweight 60 is guided between the opposing counterweight guide rails 58F and 58R.
The available space allows for a counterweight 60 that is large enough to be fitted on top with a pair of sheaves 62F and 62R.
By this arrangement of components the counterweight 60 requires minimal side to side space thus precluding the need for the width of the hoistway 50 to be increased.
Since the counterweight 60 requires a reduced side to side space, the counterweight 60 and the car sheave 66L can pass each other during up and down movement with sufficient clearance not to require additional width of the hoistway 50.
The car sheaves 66R and 66L have parallel axes of rotation and are positioned on the same linear plane perpendicular to the hoistway side walls 50R and 50L under the car 64.
Using the diameter of the drive sheave 54 as the radius and the center point of the counterweight 60 as an anchor, an arc is drawn to ascertain its intersection with the adjacent side of the car 64. The point of intersection with the car 64 is the reference point for determining a perpendicular line connecting the hoistway side walls 50R and 50L. These radii, center points, and arcs may vary depending on the arrangement of the components of the elevator system.
This perpendicular line is the center line wherein the parallel axes of rotation of the car sheaves 66R and 66L is located.
The driving machine 52 is positioned in the top of the hoistway on top of the counterweight guide rails 58F and 58R so that the drive sheave 54 connects the two reference points previously described of the center point of the counterweight 60 and the point of intersection with the car 64 where the car sheaves 66R and 66L are located.
This arrangement, wherein the forward side of the drive sheave 54 connects vertically with the car sheave 66L and the rear side of the drive sheave 54 connects vertically with the counterweight 60, assures that all of the ropes of the hoist cable 68 have a substantially vertical drop.
Additionally, this arrangement positions the car sheaves 66R and 66L along a side to side line that is proximate to the front to back center of gravity of the car 64 thus minimizing the side pressure on the car guide rails 56R and 56L.

One embodiment of the current disclosure, as illustrated in FIG. 2, depicts a specific roping arrangement associated with the counterweight 60, the machine 52, the associated drive sheave 54, the counterweight sheaves 62F and 62R, and the machine bedplate 72.
As described previously the hoist ropes 68 are engaged over the drive sheave 54 associated with the machine 52 in the top of the hoistway 50 dropping vertically from the rear side of the drive sheave 54 at approximately a center line of the counterweight 60.
The counterweight 60 is sized so that it is fitted on top with two counterweight sheaves 62F and 62R.
The counterweight 60 is guided by a pair of opposed guide rails 58F and 58R.
The machine is affixed in the top of the hoistway 50 on top of the counterweight guide rails 58F and 58R via a bedplate assembly 72.
The hoist ropes 68 drop from the rear side of the drive sheave 54 passing under the two sheaves 62F and 62R and are secured to the bedplate assembly 72 that is affixed to the counterweight guide rails 58F and 58R with hitching devices 74F and 74R.
The hoist ropes 68 are divided approximately equally under the counterweight sheaves 62F and 62R and secured respectively to the bedplate assembly 72 and the hitching devices 74F and 74R.
The described counterweight roping arrangement suspends the counterweight 60 in a 2-to-1 roping arrangement on one end of the hoist cable 68.

One embodiment of the current invention, as illustrated in FIG. 3, depicts the specific roping arrangement associated with the car 64, the machine 52, the associated drive sheave 54, and the car sheaves 66R and 66L.
As described previously, the hoist ropes 68 are engaged over the drive sheave 54 associated with the machine 52 in the top of the hoistway 50 dropping vertically from the forward side of the drive sheave 54 to the car sheave 66L.
The sheaves 66R and 66L associated with the car 64 are positioned under the car 64 creating an under slung car roping arrangement.
The hoist cable 68 drops vertically from the forward side of the drive sheave 54 to the car sheave 66L passing under the car 64 around the opposite car sheave 66R in a vertical path from the car sheave 66R to a hitching device 74C in the top of the hoistway 50.
The described car roping arrangement suspends the car in a 2-to-1 roping arrangement on one end of the hoist cable 68.
The hoist cable 68 is positioned within the clearance space between the car 64 and the counterweight 60.
The car sheave 66L nearest the counterweight 60 is positioned so that a minimal amount of the car sheave 66L protrudes beyond the vertical plane of the car 64 in order to minimize the need for clearance space between the car 64 and the counterweight 60.

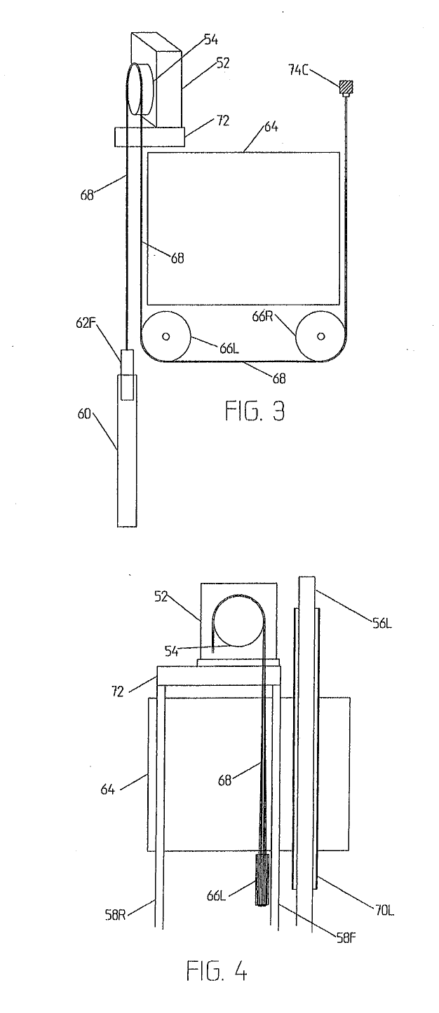

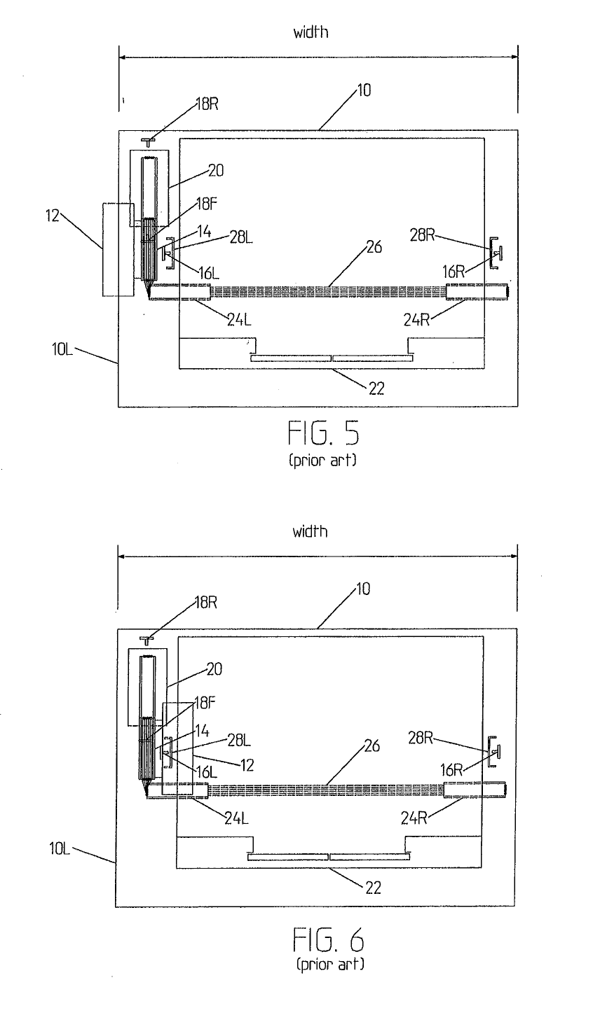

One embodiment of the current invention, as illustrated in FIG. 4, depicts the car 64 in its vertically uppermost position.
As previously described, the machine 52 and bedplate assembly 72 are affixed to the top of the counterweight guide rails 58F and 58R in the top of the hoistway.
Since the substantially vertical drop of the hoist cable 68 from the forward side of the drive sheave 54 to the car sheave 66L is aft of the car frame 70L, the portion of the car frame 70L which extends above the car 64 nests beside the machine 52 and bedplate assembly 72 when the car 64 is at its uppermost vertical point of travel.
It can be appreciated that the space in the top of the hoistway 50 is minimally impacted by this embodiment.

As described herein a worker of ordinary skill in this art will readily recognize various modifications from a traditional machine roomless elevator in the current invention. It will be further recognized that the current embodiment resolves problems outlined in the prior art by reducing the pressure on the sides of the car guide rails, reducing the need for additional hoistway width, supporting the driving unit inside the hoistway space, and reducing the space in the top of the elevator hoistway required while maintaining the required top clearance in the vertical direction between the ceiling of the elevator hoistway and the car stopped in its highest position of the elevator hoistway.

We claim:

1. An elevator system including an elevator car movable within a hoistway comprising: a machine for driving an elevator car through the hoistway; said machine having a drive sheave; a counterweight mounted in the hoistway and having two deflection sheaves; an elevator car mounted for movement in the hoistway and having two deflection sheaves; a car support frame; and a hoist cable including a plurality of ropes.

2. The elevator system as set forth in claim 1, wherein a front to back center line of said car is positioned so as to be off center of a front to back center line of said hoistway.

3. The elevator system as set forth in claim 2, wherein said machine is positioned so that said drive sheave is located in a top of said hoistway vertically above the greater of two spaces between said car and hoistway side walls.

4. The elevator system as set forth in claim 1, wherein said two deflection sheaves associated with said car are positioned under said car and oriented so that both axes of rotation are approximately parallel to each other.

5. The elevator system as set forth in claim 4, wherein said two deflection sheaves associated with said car are positioned so that said parallel axes of rotation are approximately perpendicular with hoistway sidewalls.

6. The elevator system as set forth in claim 4, wherein said two deflection sheaves associated with said car are positioned so that they are on a side to side line that is approximately at a center of gravity of said car.

7. The elevator system as set forth in claim 1, further comprising a pair of opposing guide rails for guiding said car, wherein said car guide rails are mounted at opposed longitudinal ends and parallel to an axis of rotation of said deflection sheaves associated with said car.

8. The elevator system as set forth in claim 7, wherein said guide rails for guiding said car are located on a side to side line of said hoistway that is parallel and forward of a rotational axes of said two deflection sheaves of said car.

9. The elevator system as set forth in claim 1, wherein said two deflection sheaves associated with said counterweight are positioned on top of said counterweight and oriented so that their axes of rotation are substantially parallel to each other.

10. The elevator system as set forth in claim 9, wherein said two deflection sheaves associated with the said counterweight are positioned so that said substantially parallel axes of rotation are substantially parallel with side walls of said hoistway.

11. The elevator system as set forth in claim 2, wherein said counterweight is located in a rear corner of said hoistway parallel with a side wall of said hoistway in a greater of two spaces between said car and side walls of said hoistway.

12. The elevator system as set forth in claim 10, further comprises a pair of opposing guide rails for guiding said counterweight, said counterweight guide rails being mounted at opposed longitudinal ends of axes of rotation of said deflection sheaves associated with said counterweight.

13. The elevator system as set forth in claim 12, further comprising a bedplate connecting said opposed counterweight guide rails, wherein said machine is mounted on said bedplate.

14. The elevator system as set forth in claim 13, wherein said machine and said drive sheave are positioned so that one side of a diameter of said drive sheave aligns vertically with an outbound side of the more adjacent of said deflection sheaves associated with said car, and the other side of the diameter of said drive sheave aligns vertically with a center line of said counterweight.

15. The elevator system as set forth in claim 5, wherein one end of said hoist cable including a plurality of ropes is hitched to a hitching device located in a top of said hoistway opposite said machine and on the other end is hitched to said bedplate.

16. The elevator system as set forth in claim 14, wherein said plurality of ropes aligning with a center line of said counterweight are divided approximately equally, wherein about half of said ropes traverse one said deflection sheave associated with said counterweight and hitch at one end of said bedplate; and the other about half of said ropes traverse the other said deflection sheave associated with said counterweight and hitch at the other end of said bedplate.

17. The elevator system as set forth in claim 8, wherein said car support frame aligns with said guide rails that are located forward of said rotational axes of the deflection sheaves associated with said car.

18. The elevator system as set forth in claim 17, wherein said car support frame nests beside said machine when said car is at its vertically uppermost point of travel.
